(19) United States
(12) Patent Application Publication
(10) Pub. No.: US 2022/0410678 A1
(43) Pub. Date: Dec. 29, 2022

(54) COVER AND RETAINING SYSTEM FOR VEHICLES

(71) Applicant: WORKSPORT LTD., Vaughan (CA)

(72) Inventor: Steven Rossi, Vaughan (CA)

(21) Appl. No.: 17/853,170

(22) Filed: Jun. 29, 2022

Related U.S. Application Data
(60) Provisional application No. 63/216,338, filed on Jun. 29, 2021.

(51) Int. Cl. B60J 7/08

(52) U.S. Cl. CPC B60J 7/085

(57) ABSTRACT

A covering and retaining system for mounting to the cargo box of a pickup truck, which includes a front wall, a rear wall, first and second sidewalls extending between the front and rear walls. The system includes a housing attachable to the bed and extending generally between the first and second sidewalls. A retaining medium is provided within the housing and is extendible from the housing between retracted and extended positions. The retaining medium being in a free state and unsecured to the cargo box moving of the retaining medium between the retracted and extended positions.

### CROSS REFERENCE TO RELATED APPLICATION

This application is a nonprovisional patent application claim priority to provisional patent application no. 63/216,338, filed Jun. 29, 2021, the entire contents of which are herein incorporated by reference.

### BACKGROUND

### 1. Field of the Invention

The present invention generally relates to an accessory for motor vehicles. More specifically, the present invention relates to truck bed accessories having a covering and retaining medium that can be extended relative to the length of the bed.

### 2. Description of Related Art

An advantage of a pickup truck (hereafter just “truck”) is the ability to haul or store cargo in the bed of the truck. One truck bed accessories that exists to cover the bed of the truck is commonly referred to as a tonneau cover. Many different varieties of tonneau covers exist, including fabric and slat-type covers that detach from rails along the side of the bed and can be rolled up from the rear of the bed toward the cab of the truck. Similar tonneau covers exist that can be rolled into a housing mounted to the bed of the truck.

A problem with these types of tonneau covers is that they are designed to cover the bed of the truck generally at the height of the top of the bed. Therefore, the cargo in the bed must be lower than the height of the top of the walls (bulkhead, sidewalls and tailgate) defining the bed. Existing tonneau covers are not designed to be extended over cargo having a height that extends above the walls of the bed.

Tarps, in flexible sheet form, are also available for covering the bed of a truck. The tarp must be secured by ropes, tie-down straps, bungie cords or rubber straps and S-hooks over the walls of the bed or to tie down hooks provided in the bed of the truck.

Other tarp systems exist for covering dump beds of trucks equipped with such dump beds. These systems generally employ a roller, located toward the front of the dump bed, about which is wound a mesh tarp that can be extended over the dump bed. The tarp is pulled rearward over the bed, usually with ropes, to cover loose contents, such as gravel, located in the bed. At the rear of the dump bed, the tarp is secured by rubber straps with S-hooks, tie-downs with hooks or just rope. The roller is equipped with a ratchet mechanism and crank handle to tighten down the tarp and, when not in use, to roll the tarp onto the roller.

As seen from the above discussion, tonneau covers and tarps each have their own advantages and their own limitations. A system incorporating the benefits of both does not exist.

### SUMMARY

In satisfying the above need, as well as overcoming the enumerated drawbacks and other limitations of the related art, the present invention provides a covering and retaining system for mounting in the cargo box of a pickup truck

In one aspect, the invention provides a covering and retaining system for mounting in the cargo box, the cargo box including a front wall, a rear wall, first and second sidewalls extending between the front and rear walls, and a bottom wall, the front wall, rear wall, first sidewall and second sidewall defining a bed of the truck. The system includes a housing and a retaining medium. The housing is attachable to the bed so as to extend between the first and second sidewalls. The retaining medium is provided within the housing and is extendible from the housing between retracted and extended positions. The retaining medium freely extends from the housing during movement between the retracted and extended positions.

In another aspect, in the retracted position the retaining medium is contained within the housing.

In a further aspect, in the extended position the retaining medium extends from the housing in a length covering the cargo box from the housing to at least the rear wall of the cargo box.

In an additional aspect, in the extended position the retaining medium extends from the housing in a length greater than a length covering the cargo box from the housing to the rear wall of the cargo box.

In yet another aspect, the housing includes a slot, the retaining member extending from the housing through the slot in the extended position.

In still a further aspect, wherein in the retracted position a leading end of the retaining member extends from the housing.

In an additional aspect, the housing includes a slot, and in the retracted position a leading end of the retaining member extends from the housing through the slot.

In another aspect, the retaining medium includes lateral side edges configured to be located adjacent to the first and second side walls of the bed, the lateral side edges being free lateral edges.

In yet a further aspect, the lateral side edges include retaining members defined therein.

In an additional aspect, the retaining members are loops, the loops being one of provided along the lateral side edges or defined in the lateral side edges.

In still another aspect, the retaining medium includes lateral side edges configured to be located adjacent to the first and second side walls of the bed, the retaining medium further including a lead end extending between the first and second side edges.

In a further aspect, the lead end includes retaining members defined therein.

In yet an additional aspect, the system includes at least one support member.

In another aspect, the support member is configured for extending between the first and second side walls of the bed, the retaining medium extending over the support member in the extended position.

In sill a further aspect, the housing includes at least one holder provided thereon, the holder releasably engaging the support member.

In an additional aspect, the holder is provided on an exterior surface of the housing.

In another aspect, the support member includes an outer sleeve, the outer sleeve being rotatable.

In a further aspect, the retaining medium is biased into the retracted position.

In an additional aspect, the housing includes a top surface and is configured for flush mounting of the top surface with top surfaces of the cargo box.

In yet another aspect, the system is provided in combination with a tonneau cover, the tonneau cover having a covered position and an uncovered positon. In the covered positon the tonneau cover extending over and covering the cargo box, the tonneau cover having a plurality of sections and being foldable into a stack of the sections.

Further objects, features and advantages of this invention will become readily apparent to persons skilled in the art after review of the following description, including the claims, and with reference to the drawings that are appended to and form a part of this specification.

### BRIEF DESCRIPTION OF THE DRAWINGS

FIG. 1 is a perspective view of a pickup truck having a retractable covering and retaining system, according to the principles of the present invention, mounted with the bed thereof and showing the tarp retracted into the tarp canister.

FIG. 2 is a cross sectional view, with portions broken away, of the truck and covering and retaining system seen in FIG. 1.

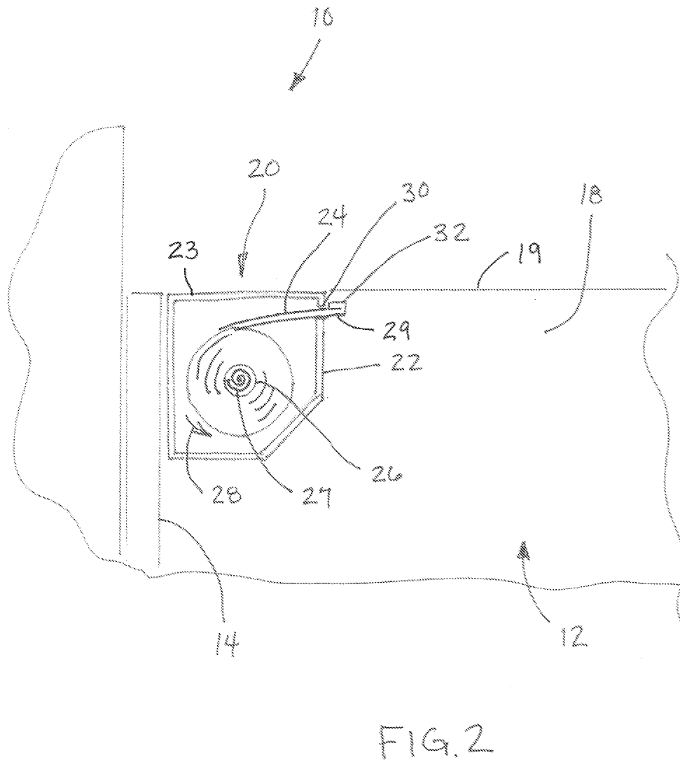

FIG. 3A is a perspective view of the pickup truck and retractable covering and retaining system showing the tarp (as a mesh or non-mesh tarp) extended from the tarp canister and over the bed of the truck, generally flush with the top of the walls defining the bed.

FIG. 3B is a perspective view of the pickup truck and retractable covering and retaining system showing the tarp (as an elastic cargo net) extended from the tarp canister and over the bed of the truck, generally flush with the top of the walls defining the bed.

FIG. 4 is a cross sectional view, with portions broken away, of the truck and covering and retaining system seen in FIGS. 3A and 3B.

FIG. 5 is a perspective view of the pickup truck and covering and retaining system showing the tarp extended from the tarp canister and over the bed of the truck, generally forming a liner along the bottom wall of the bed and with the tailgate of the bed being closed.

FIG. 6 is a cross sectional view, with portions broken away, of the truck and covering and retaining system seen in FIG. 5.

FIG. 7. is a perspective view of the pickup truck and covering and retaining system showing the tarp extended from the tarp canister and over the bed of the truck like FIG. 5, but with the tailgate of the bed in a lowered position.

FIG. 8 is similar to FIG. 7 and is a perspective view of the pickup truck and covering and retaining system showing the tarp extended from the tarp canister and forming a bed divided within the bed of the truck.

FIG. 9 is a perspective view of the pickup truck and covering and retaining system showing the tarp extended from the tarp canister and over the bed of the truck, generally over a load in the bed of the truck that raises above the top of the walls defining the bed.

FIG. 10 is a cross sectional view, with portions broken away, of the truck and covering and retaining system seen in FIG. 9.

FIG. 11 is a perspective view of the pickup truck and showing a tonneau cover located over the covering and retaining system that is located in the bed of the truck.

FIG. 12 is a cross sectional view, with portions broken away, of the truck, tonneau cover and covering and retaining system seen in FIG. 11.

### DETAILED DESCRIPTION

As used in the description that follows, directional terms such as “upper” and “lower” are used with reference to the orientation of the elements as presented in the figures. Accordingly, “upper” indicates a direction toward the top of the figure and “lower” indicates a direction toward the bottom of the figure. The terms “left” and “right” are similarly interpreted. The terms “inward” or “inner” and “outward” or “outer” indicate a direction that is generally toward or away from a central axis of the referred to part whether or not such an access is designated in the figures. An axial surface is therefore one that faces in the axial direction. In other words, an axial surface faces in a direction along the central axis. A radial surface therefore faces radially, generally away from or toward the central axis. It will be understood, however, that in actual implementation, the directional references used herein may not necessarily correspond with the installation and orientation of the corresponding components or device.

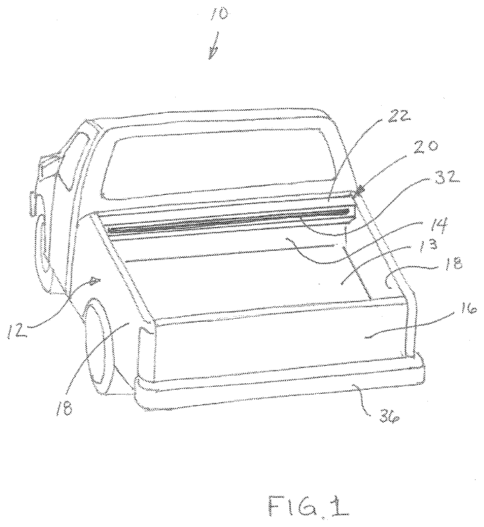

Referring now to the drawings, seen in FIG. 1 is an accessory embodying the principles of the present invention, referred to herein as a retractable covering and retaining system, for the cargo box or bed 12 of a pickup truck 10 (“truck”). The bed 12 is generally defined by a bottom wall 13, front wall or bulkhead 14, a rear wall or tailgate 16, and opposing sidewalls 18 extending therebetween. The covering and retaining system (“system”), generally designated at 20, includes as its principal components a housing or tarp canister 22 (“canister”) in which is housed a retaining medium 24, which is further discussed below.

The system 10 is mounted within the bed 12 of the truck 10, preferably adjacent to the bulkhead 14, and extends laterally across the width of the bed 12. In mounting the canister 22, the canister 22 is positioned so that a top surface 23 of the canister 22 does not rise above the upper surface 19 of the walls 14, 16, 18 defining the bed 12. The canister 22 may be bolted directed to the bed 12 or may be mounted to the bed 12 using releasable clamps and/or brackets. As such, the canister 22 may be secured to side walls 18 or the bulkhead 14, or both, of the bed 12.

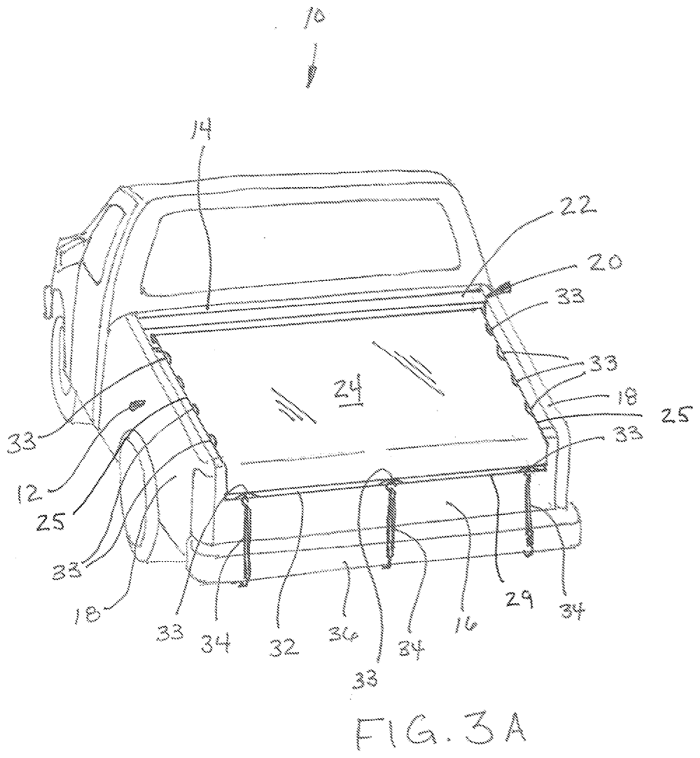

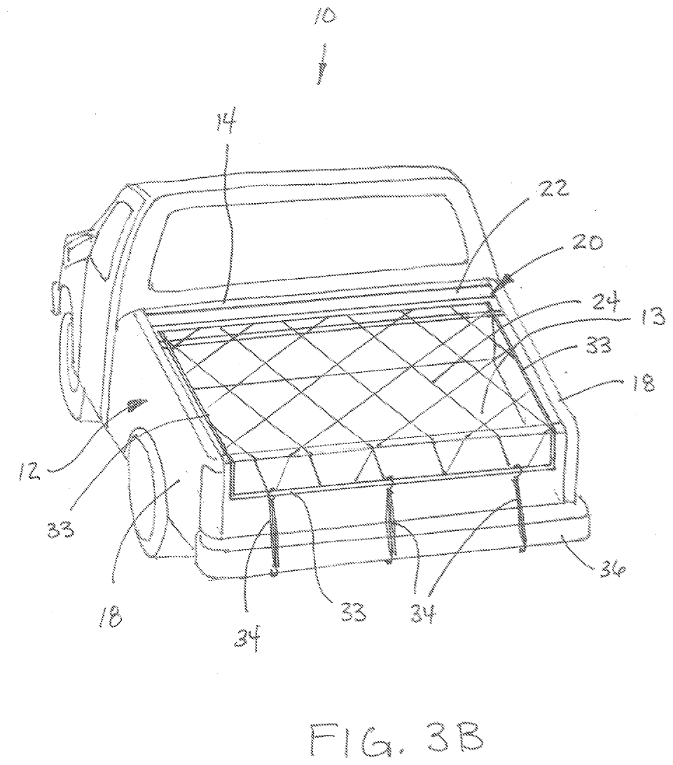

While not being limited thereto, the retaining medium 24 is preferably an cargo net, a mesh tarp, or a non-mesh tarp or another flexible, non-self-supporting sheet-like material. The medium 24 may be elastic or inelastic and it may also be waterproof, water resistant or neither waterproof nor water resistant. The lateral sides 25 of the medium 24 (the sides 25 adjacent to sidewalls 18 of the bed 12) and the lead end 29 (the end 29 exiting the canister) may be seamed 32 and/or formed with loops 33 at spaced apart locations thereon. If proved with loops 33, the loops 33 may be integral with the sides 25 and end 29 of the medium 24 (defined by the sides 25 and end 29 themselves, as seen in FIG. 3) or may be formed as extensions off of the sides 25 and ends 29.

The canister 22 forms an enclosure within which the medium 22 is received on a roller shaft 26 (“roller”). The roller 26 is rotatably supported within the canister 22 and is preferably spring 27 biased in a direction, indicated by arrow 28, urging and rolling the medium 24 onto the roller 26. The end 29 of the medium 24 exits the canister 22 through a slot 30 and by grasping the loops 33 or seam 32 on the end of the medium 24, the medium 24 may be pulled from the canister 22, against the biasing force of the spring 27, and extended from the stored position within the canister 22. In place of or in addition to the loops 33, the end 29 of the medium 24 may include one or more grips or a rope/strap (not shown) attached to the end of the medium 24. Notably, when initially extended from the canister 22, the sides 25 and ends 29 of the medium 24 are free from the bed 12 and are not supported or self-supporting. In other words, the side 25 and ends 29 of the medium 24 will fall into the bed 12 if let go. It is only after extending the medium 24 that the sides 25 and end 29 of the medium 24 are or can be secured to features provided in the bed 12 or to/over the tailgate 16. To prevent rewinding of the medium 24 back onto the roller 26, the roller 26 may include spring biased pawls that pivotally engage a toothed ring or wheel (not shown) as the medium 24 is pulled off of the roller 26. When allowed to rotate sufficiently fast, the pawls remain disengaged from the teeth under centrifugal forces and allow the medium 24 to be rolled upon the roller 26 under the influence of the biasing spring 27.

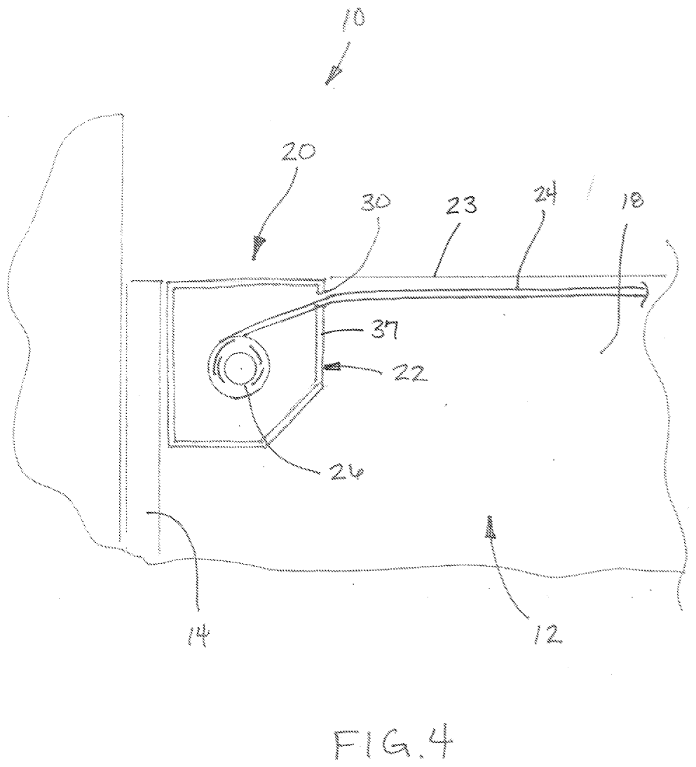

As seen in FIGS. 3A and 3B, the medium 24, shown as a tarp, has been extended from the canister 22 so as to extend the full length of the bed 12 and over the tailgate 16, where it has been secured by bungie cords 34 hooked to the loops 33 on the end 29 of the tarp 24 and to a portion of the truck, such as the bumper 36. While shown as being secured with bungie cords 34, it will be appreciated that the tarp 24 may be secured by any suitable means, including tie downs, ropes, webbed straps, rubber straps, etc. Also, while being shown secured to the bumper 36, it will be appreciated that the tarp 24 may be secured to tie down anchors or hooks (not shown) provided within the bed 12 of the truck 10. As seen in FIG. 4, the tarp 24 is generally even with the top surface 23 of the walls 14, 16, 18 defining the bed 12 of the truck 10 and its specific location relative to the top surface of the side walls 14, 16, 18 may vary depending on the specific location of the slot 30, which is shown toward the top of the rear wall 37 of the canister 22 in the figures, but which could be located elsewhere. Extended in this manner, the tarp 24 retain the load (not shown in FIG. 4) in the bed 12 and prevents the load or small pieces of the load, like aggregate, from being ejected from the bed 12 during travel.

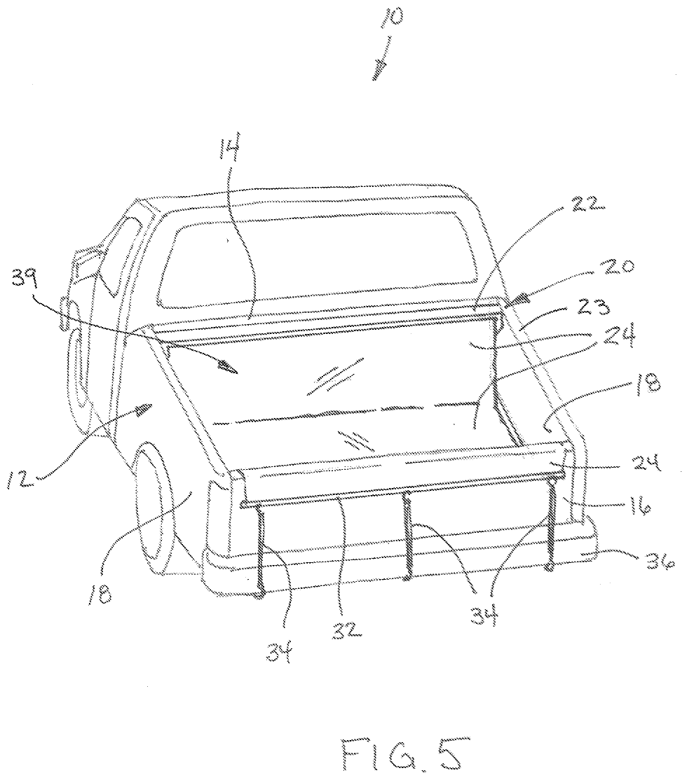

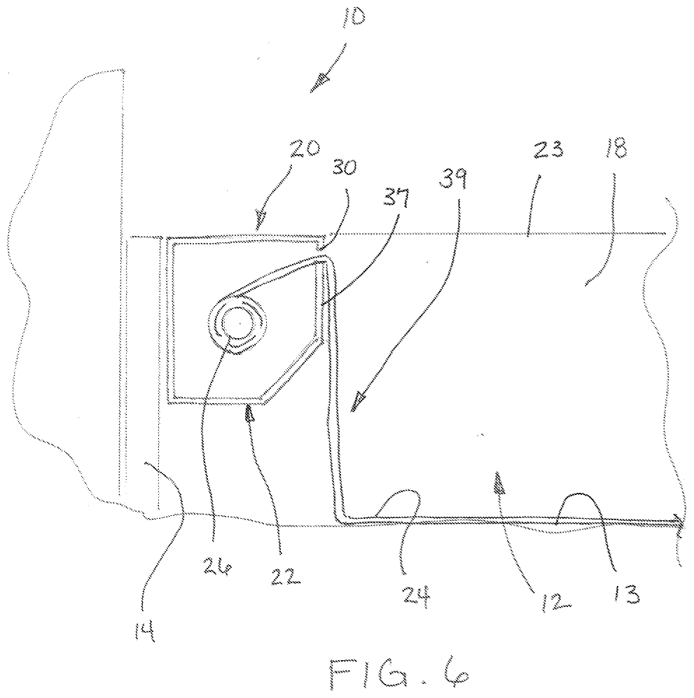

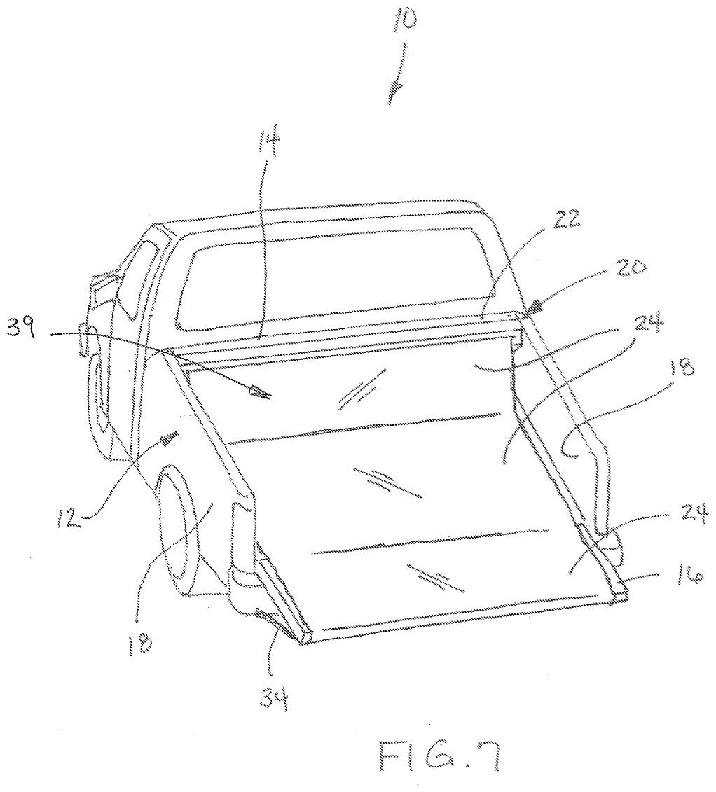

FIGS. 5 and 6 show the tarp 24 extended from the canister 22 so as to form a liner 39 within the bed 12. In this liner position, the tarp 24 extends downward from the slot 30 and rests on the bottom wall 13 of the bed 12. The tarp 24 may extend up and over the tailgate 16 when closed, as shown in FIG. 5, or may extend over the tailgate 16 when lowered, as seen in FIG. 7. While protecting the bed 12 from a load positioned on the tarp 24, in this position, the tarp 24 may also be used as a cargo unloader. By disconnecting the tarp from the bumper, the tarp may then be pulled further from the canister by the end loops 33 or grips, causing the load to be pulled off of the bed 12. In this regard, the tarp 24 will have a length longer than the length of the bed 12, and perhaps as much as three times the length of the bed 12. The tarp 24 may be pulled in various ways. Illustrative, non-limiting examples include manually, by attaching it to a fixed object and moving the truck 12, or by a winch mounted to the front of the truck 10 and a cable (not shown) routed back under the truck 10 to the tarp 42.

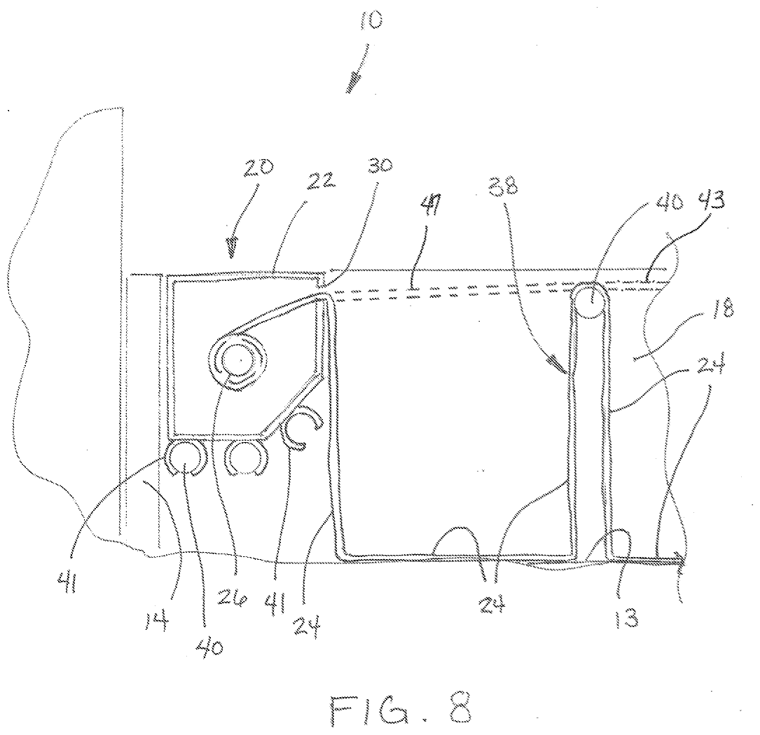

As generally depicted in FIG. 8, the tarp 42 may also be utilized to form one or more bed dividers 38 extending laterally between the sidewalls 18 of the bed 12. In forming a bed divider 38, the tarp 42 is first laid along the bottom wall 13 of the bed 12, and is then extended up and over a support or cargo bar 40 positioned and extending laterally between the sidewalls 18 of the bed 12. Preferably, the support 40 is adjustable in length for easier positioning between the sidewalls 18. The adjustable length may be achieved via spring loaded telescopic members, rotationally adjustable members, ratcheting members or other well-known mechanisms. Provided in this manner, the location of the bed divider 38 is not predetermined and may be customized for the particular intended use. Additionally, the bed divider 38 may be provided in a position located after, or before, a section of the tarp 42 that is provided as a covering over a given length of the bed 12. This is respectively shown in FIG. 8 via the dashed lines 47 and dash-dot-dash lines 43.

For storage of the supports 40, the canister 22 may be provided on one or more of its exterior surfaces with spring/resilient clips 41 that engage the shaft of the supports 40 and retain them along the canister 22 when not in use. Representative clips 41, which may be formed as plastic C-clips having resilient arms, are illustrated in FIG. 8.

The supports 40 themselves may be simply bars or rods, adjustable in length, for mounting between the sidewalls 18 of the bed 12, as noted above. Alternatively, a support 40 may include a freely rotatable outer sleeve, which may further a features for attaching the end 29 of the tarp 24. Provided with a ratchet, handle or other mechanism to roll the tarp 24 onto the sleeve, such a support 40 and sleeve enables the tarp 24 to be used as a conveyor for the off-loading of material from the bed 12, as generally discussed above. As another alternative, the support 40 may be provided in the form of a double cargo bar having vertically spaced apart upper and lower bars, with a divider therebetween. In such a construction, the divider being a flexible material, scissoring members or other means extending between the bars of the double cargo bar version of the support 40.

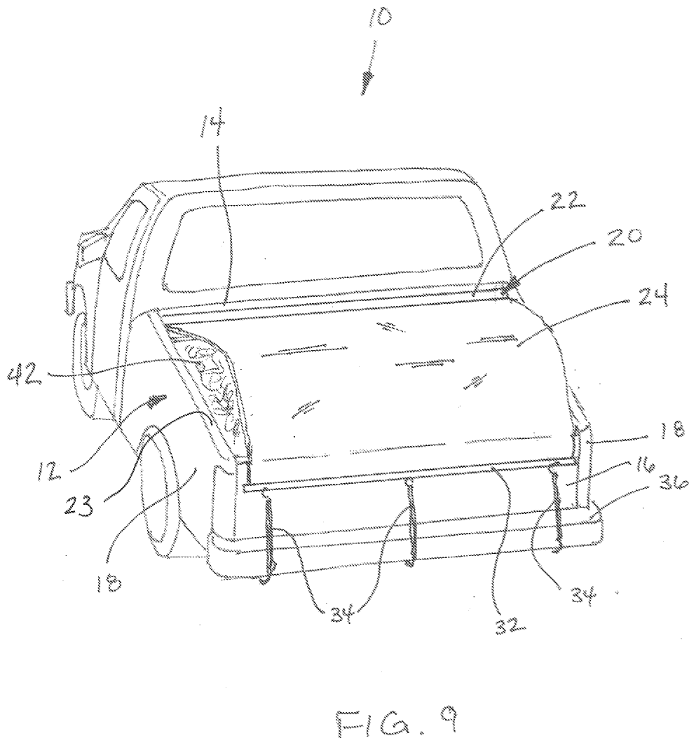

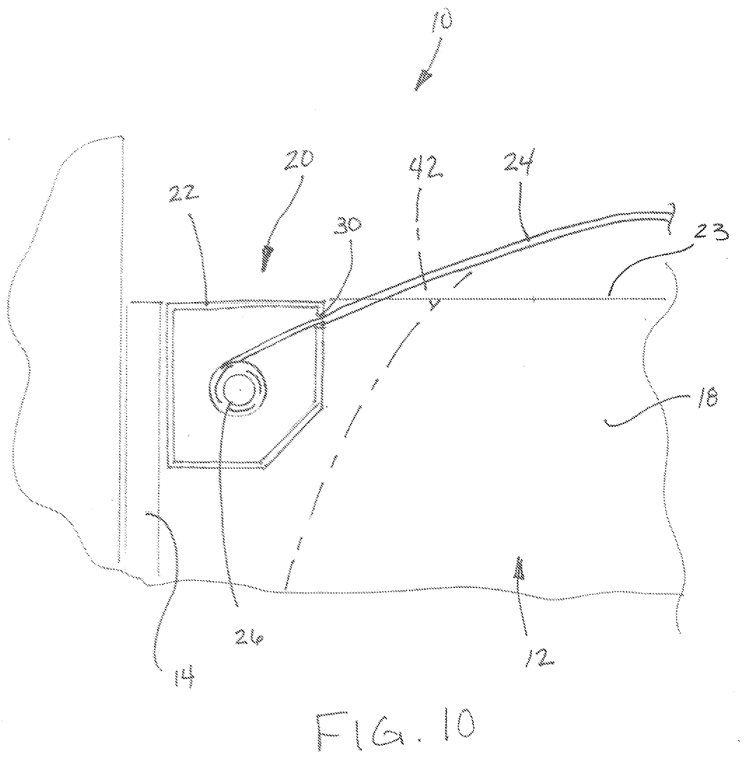

As seen in FIGS. 9 and 10, the tarp may also be used to cover a load, which is designated 42, such as a load of mulch, that rises above the top surface 23 of the side walls 18 of the bed 12. Extended in this manner, the tarp 42 retains the mulch in the bed and inhibits/prevents pieces of mulch from being ejected out the bed 12 during travel. When provided in an elastic form, the sides 25 of the tarp 42 may be stretched downward into the bed 12 and secured to tie down anchors, further retaining the mulch, or other load, within the bed 12.

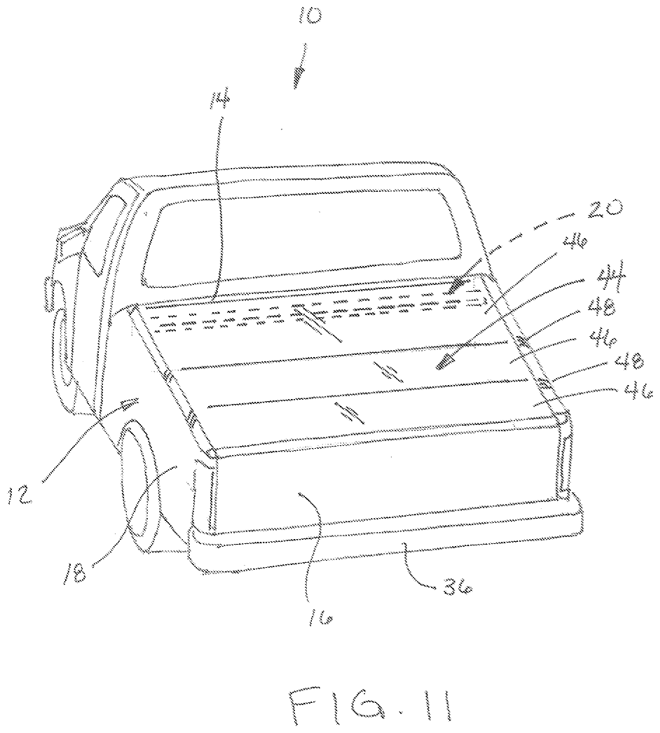

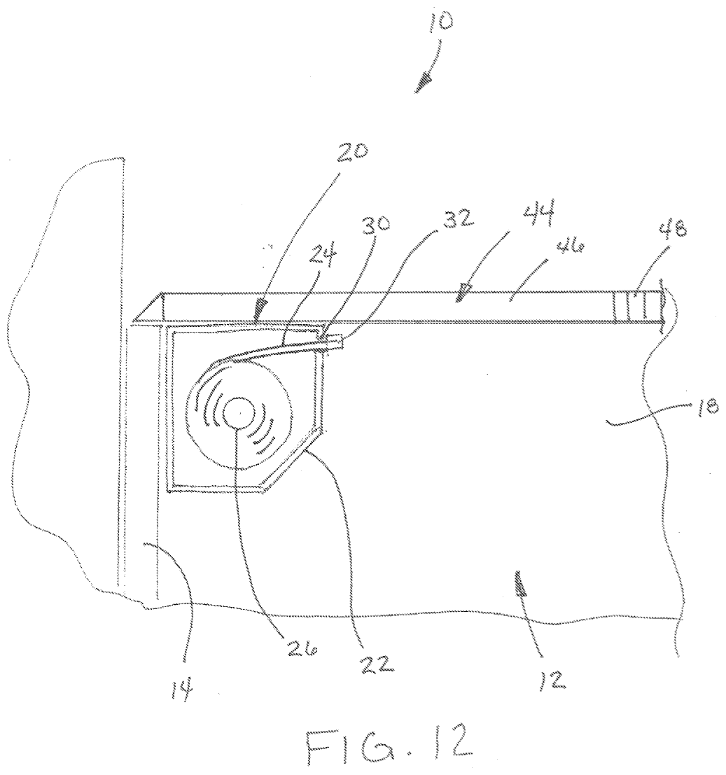

Mounted within the bed 12 as discussed above, the position of the canister 22 allows the system 20 to be simultaneously used with a tonneau cover 44, as seen in FIGS. 11 and 12. The tonneau cover 44 may be of a kind that is mounted onto the top surfaces 23 of the various walls 14, 16, 18 defining the bed 12. Alternatively, the tonneau cover 44 may mount partially within the bed 12 of the truck 10, flush with the top 23 of the sidewalls 18. This can be achieved by mounting the canister 22 of the system 20 in the same relative position, but lower within the bed 12 of the truck 10. While they may be of a non-folding variety, typically a tonneau cover 44 includes a series of soft or hard sections 46 that are connected together by hinges 48 so that they may be folded back upon themselves, proceeding from the tailgate 16 toward the bulkhead 14, and so as to progressively expose the bed 12. Clamps and latches (not shown) are used to secure the tonneau cover 44 to the bed 12 and permit its folding. Since tonneau covers 44 and their means of mounting are well known, they are not further discussed herein.

As a person skilled in the art will readily appreciate, the above description is only meant as an illustration of an implementation of the various aspects and principles of the present invention. Accordingly, this description is not intended to limit the scope or application of this invention since the invention is susceptible to modification, variation and change, all without departing from the spirit of the invention.

I/We claim:

1. A covering and retaining system for mounting in the cargo box of a pickup truck, the cargo box including a front wall, a rear wall, first and second sidewalls extending between the front and rear walls, and a bottom wall, the front wall, rear wall, first sidewall and second sidewall defining a bed of the truck, the system comprising;
a housing attachable to the bed and extending between the first and second sidewalls; and
a retaining medium provided within the housing, the retaining medium being extendible from the housing between retracted and extended positions, the retaining medium being in a free state and unsecured to the bed during extending between the retracted and extended positions.

2. The covering and retaining system according to claim 1, wherein in the retracted position the retaining medium is contained within the housing.

3. The covering and retaining system according to claim 1, wherein in the extended position the retaining medium extends from the housing in a length covering the cargo box from the housing to at least the rear wall of the cargo box.

4. The covering and retaining system according to claim 1, wherein in the extended position the retaining medium extends from the housing in a length greater than a length covering the cargo box from the housing to the rear wall of the cargo box.

5. The covering and retaining system according to claim 1, wherein the housing includes a slot, the retaining member extending from the housing through the slot in the extended position.

6. The covering and retaining system according to claim 1, wherein in the retracted position a leading end of the retaining member extends from the housing.

7. The covering and retaining system according to claim 1, wherein the housing includes a slot, and in the retracted position a leading end of the retaining member extends from the housing through the slot.

8. The covering and retaining system according to claim 1, wherein the retaining medium includes lateral side edges configured to be located adjacent to the first and second side walls of the bed, the lateral side edges being free lateral edges.

9. The covering and retaining system according to claim 8, wherein the lateral side edges include retaining members defined therein.

10. The covering and retaining system according to claim 9, wherein the retaining members are loops, the loops being one of provided along the lateral side edges or defined in the lateral side edges.

11. The covering and retaining system according to claim 1, wherein the retaining medium includes lateral side edges configured to be located adjacent to the first and second side walls of the bed, the retaining medium further including a lead end extending between the first and second side edges.

12. The covering and retaining system according to claim 11, wherein the lead end includes retaining members defined therein.

13. The covering and retaining system according to claim 1, further comprising at least one support member.

14. The covering and retaining system according to claim 13, wherein the support member configured for extending between the first and second side walls of the bed, the retaining medium extending over the support member in the extended position.

15. The covering and retaining system according to claim 13, wherein the housing includes at least one holder provided thereon, the holder releasably engaging the support member.

16. The covering and retaining system according to claim 15, wherein the holder is provided on an exterior surface of the housing.

17. The covering and retaining system according to claim 13, wherein the support member includes an outer sleeve, the outer sleeve being rotatable.

18. The covering and retaining system according to claim 1, wherein the retaining medium is biased into the retracted position.

19. The covering and retaining system according to claim 1, wherein the housing includes a top surface and is configured for flush mounting of the top surface with top surfaces of the cargo box.

20. The covering and retaining system according to claim 1, in combination with a tonneau cover, the tonneau cover having a covered position and an uncovered positon, in the covered positon the tonneau cover extending over and covering the cargo box, the tonneau cover having a plurality of sections and being foldable into a stack of the sections.
